(19) United States
(12) Patent Application Publication
(10) Pub. No.: US 2024/0392681 A1
(43) Pub. Date: Nov. 28, 2024

(54) DOWNHOLE COMPUTING SYSTEM AND METHOD FOR PRECISE REAL-TIME COMPUTATION OF DEPTH TRACKING, TRUE VERTICAL DEPTH, AND RATE OF PENETRATION

(71) Applicant: Deere Development Company, LLC, Cedar Park, TX (US)

(72) Inventors: R. Paul Deere, Cedar Park, TX (US); Enrique Z. Losoya, Houston, TX (US)

(73) Assignee: Deere Development Company, LLC, Cedar Park, TX (US)

(21) Appl. No.: 18/668,119

(22) Filed: May 17, 2024

Related U.S. Application Data
(60) Provisional application No. 63/504,354, filed on May 25, 2023.

(51) Int. Cl. E21B 47/04; G01V 11/00

(52) U.S. Cl. CPC E21B 47/04; G01V 11/002; E21B 2200/22

(57) ABSTRACT

An apparatus and method for estimating measured depth, rate of penetration, and true vertical depth of a drill bit and bottom hole assembly in a borehole using multiple longitudinally separated sensors for detecting properties of the borehole or formation and an orientation sensor. The multiple sensors may be paired with each pair of sensors including a first sensor and a second sensor. The sensors within a pair may be of the same of different types. The rate of penetration can be determined by comparing trends derived from data gathered by the longitudinally separated sensors and the time at which each records specific features of the formation or borehole. Multi-sensor fusion may be employed to enhance the accuracy of the orientation estimation. Combined with orientation information, a known longitudinal separation, and a measured depth, the true vertical depth can be determined without input from the surface.

### BACKGROUND OF THE DISCLOSURE

### 1. Field of the Disclosure

This disclosure relates to the field of downhole tools associated with directional drilling, measurement-while-drilling (MWD), and logging-while drilling (LWD) in earth formations, especially to track measured depth (MD) and true vertical depth (TVD) while downhole.

### 2. Description of the Related Art

Rotary drilling in earth formations is used to form boreholes for obtaining materials in the formations, such as hydrocarbons. Rotary drilling involves a bottom hole assembly disposed on a drilling end of a drill string that extends from the surface. The drill string is made up of a series of tubular members that connect the bottom hole assembly to the surface. The bottom hole assembly may include a drill bit, which, when rotated, may disintegrate the earth formations to drill the borehole. Above and proximate to the drill bit may be formation and/or borehole devices and measurement tools for measuring, recording, and/or reporting information about the condition of the formation, borehole, bottom hole assembly, or other aspects of the drilling environment.

The sensors are configured for operations during drilling and are generally referred to as logging-while-drilling (LWD) or measurement-while-drilling (MWD) sensors. The sensors may include suitable detectors configured to gather information about the borehole and surrounding rock formation (geological information), the health of the drill string (status information), and disposition of the rotary drill (orientation information). Suitable detectors may include radiation detectors, acoustic sensors, and thermal sensors.

Currently, orientation and geological information is measured downhole below the surface and then transmitted to the surface. Depth information is measured at the surface (uphole). Measuring depth at the surface does not take into account pipe stretching and compression. Additionally, orientation measurements, also called surveys, are transmitted to the surface at every connection, usually around 90 feet (27 meters), and it is assumed by the directional driller that the drilling assembly traveled in a straight line from one survey point to the next, which is not always the case. These errors result in misplacement of the wellbore from the desired location. If a wellbore is not in the optimal location, the result is likely to be an underperforming well. By continually measuring depth, TVD and rate of penetration (ROP) downhole, the depth measurement errors caused by pipe stretching and compression will be eliminated and by accurately tracking the trajectory of the wellbore from once connection to the next, a more accurate knowledge of the actual trajectory and depth of the wellbore will become apparent, allowing for better and more consistent placement of the wellbore downhole.

Additionally, downhole and uphole information are combined so that steering decisions regarding the rotary bit can be made at the surface. However, the slow transmission rate between downhole instrumentation and the surface—usually made through mud pulse telemetry or electromagnetic telemetry—slows down the drilling process. The Oil & Gas Drilling Exploration Industry is always looking to decrease the time it takes to drill a well. However, slow data transmission between downhole and the surface keeps this from happening. While MWD and LWD tools provide required drilling data to ‘drive’ the drill bit from the surface, the weak link in the chain is the delay in getting the data to the surface. Downhole depth determination (TVD and MD) remains largely unaddressed. Providing downhole depth access would unlock new possibilities for novel automated solutions and systems in the industry. Potentially saving millions of dollars annually.

Therefore, what is needed is a system that measures both orientation and depth downhole so that wellbore trajectory and depth is more accurate and the possibility of a self-steering BHA can emerge. With depth and orientation information, a drill bit can be auto-steered. This will reduce drilling time and create more accurate wellbores and wellbore placement. What is also needed is a system that determines True Vertical Depth, Orientation, and Measured Depth continuously while downhole without input from the surface.

### BRIEF SUMMARY OF THE DISCLOSURE

In aspects, the present disclosure is related to downhole tools associated with rotary drilling in earth formations. Specifically, the present disclosure is related to continuously determining measured depth, orientation, and true vertical depth of a drill bit located downhole in real time without input from the surface.

One embodiment includes a method for determining measured depth in a borehole, including the steps of: moving a first sensor and a second sensor through a borehole while continuously sending data to a processor, wherein the first sensor and the second sensor are spaced longitudinally apart in the borehole by a known distance; continuously recording data from first sensor and the second sensor, using the processor, to a memory, wherein the processor and the memory are in the borehole; forming data trends based on the first sensor data and the second sensor data; identifying a feature of interest in each of the first sensor data trend and the second sensor data trend using time-varying pattern matching between the two trends even when the rate of penetration varies; and estimating a measured depth using the feature of interest identification in the first sensor data trend and the second sensor data trend and the known distance between the first sensor and the second sensor. The method may also include the steps of: moving an orientation sensor through the borehole with the first sensor and the second sensor; continuously recording orientation data from the orientation sensor, using the processor, to the memory; and estimating a true vertical depth using the measured depth and the orientation data. The method may also include steps of: moving a clock through the borehole with the processor; recording time information associated with the first sensor data trend and the second sensor data trend; estimating a time interval by comparing the time in each of the first sensor data trend and the second sensor data trend when the feature of interest is encountered by its respective sensor; and estimating a rate of penetration based known distance between the first sensor and the second sensor and the time interval. The first sensor and the second sensor may each be one of: an acoustic sensor, a gamma-ray sensor, a neutron sensor, and an ultrasonic sensor. The method may include one or more of: filtering, scaling, normalizing, and transforming the sensor data into a suitable format for the time-varying pattern matching techniques before forming the data trends. The pattern matching may include using at least one of: Advanced Sequential Pattern Matching Algorithms and Deep Neural-Network Based Algorithms. The Advanced Sequential Pattern Matching Algorithms may include one or more of: Dynamic Time Warping (DTW), Time Warp Edit Distance (TWED), Longest Common Subsequence (LCSS), Correlation Filtering, Cross-Correlation, Convolution, Edit Distance with Real Penalty (ERP), FastDTW, and Subsequence Dynamic Time Warping (SDTW). The Deep Neural-Network Based Algorithms comprise one or more of: Hidden Markov Models (HMM), Recurrent Neural Networks (RNN), Convolutional Neural Networks (CNN), Graph Neural Networks (GNN), Transformers, Sequence (Seq2Seq) Neural Network-based models, and Reinforcement Learning Algorithms. The time-varying pattern matching may be implemented on one of: a Digital Signal Processor (DSP), a machine learning device, a tensor processing unit, and an artificial intelligence accelerator.

Another embodiment according to the present disclosure includes a non-transitory computer-readable medium product, the medium containing instructions thereon that, when executed by a processor, executes a method, the method including the steps of: continuously recording data from a first sensor and a second sensor to a memory, using a processor, wherein the first sensor, the second sensor, the processor and the memory are moving in a borehole; retrieving the first sensor data and the second sensor data and forming data trends based on the first sensor data and the second sensor data; identifying a feature of interest in each of the first sensor data trend and the second sensor data trend using time-varying pattern matching between the two trends; and estimating a measured depth using the feature of interest identification in the first sensor data trend and the second sensor data trend and a known distance between the first sensor and the second sensor. The medium may further include instructions thereon that, when executed by the processor, executes the steps of: continuously recording orientation data from an orientation sensor moving through the borehole with the first sensor and the second sensor; and continuously estimating a true vertical depth using the measured depth and the orientation data. The medium may further include instructions thereon that, when executed by the processor executes that steps of: recording time information associated with the first sensor data trend and the second sensor data trend; and estimating a time interval by comparing the time in each of the first sensor data trend and the second sensor data trend when the feature of interest is encountered by its respective sensor; and estimating a rate of penetration based the known distance between the first sensor and the second sensor and the time interval. The medium may include one or more of: i) a ROM, ii) an EPROM, iii) an EEPROM, iv) a flash memory, v) an optical disk, vi) a solid state drive, and vii) a hard drive.

Another embodiment according to the present disclosure includes an apparatus for detecting properties of an earth formation or borehole when positioned within the borehole, the apparatus including: a first sensor; a second sensor spaced longitudinally apart from the first sensor by a known distance; a processor in electronic communication with the first sensor and the second sensor; and a memory configured to store data from the first sensor and the second sensor. The first sensor and the second sensor may be selected from a list of passive gamma ray detectors, active gamma ray detectors, ultrasonic sensors, gravimeters, acoustic sensors, and magnetometers. The first sensor and the second sensor may be the same type of sensor. The apparatus may further include an orientation sensor in electronic communication with the processor and wherein the memory is configured to store data from the orientation sensor. The apparatus may include a clock and/or the processor may include a clock circuit. The memory may include a program memory and a data memory.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

A better understanding of the present disclosure can be obtained with the following detailed descriptions of the various disclosed embodiments in the drawings, which are given by way of illustration only, and thus are not limiting the present disclosure, and wherein:

FIG. 1 is a diagram of a drilling system with a bottom hole assembly configured for use in a borehole that includes an array of sensors according to one embodiment of the present disclosure;

FIG. 2A is a diagram of a bottom hole assembly in a vertical borehole using an array of sensors at a first time during the drilling process according to one embodiment of the present disclosure;

FIG. 2B is a diagram of a bottom hole assembly in a vertical borehole using an array of sensors of FIG. 2A at a second time during the drilling process according to one embodiment of the present disclosure;

FIG. 3A is a diagram of a bottom hole assembly in a non-vertical borehole using an array of sensors at a first time during the drilling process according to one embodiment of the present disclosure;

FIG. 3B is a diagram of a bottom hole assembly in a non-vertical borehole using an array of sensors of FIG. 3A at a second time during the drilling process according to one embodiment of the present disclosure;

FIG. 4 is a diagram of a processor and sensor system configured to determine true vertical depth, orientation, and measured depth according to one embodiment of the present disclosure; and

FIG. 5 is an exemplary method of for determining measured depth, rate of penetration, and true vertical depth according to one embodiment of the present disclosure.

### DETAILED DESCRIPTION OF THE DISCLOSURE

In aspects, the present disclosure is related to downhole drilling operations. Specifically, the present disclosure is related to determining the position of a downhole apparatus within a borehole. The true vertical depth, orientation, and measured depth may be determined so that the bottom hole assembly can respond to its drilling environment and execute a drilling plan without relying on communication with the surface for instructions under some drilling conditions. When the measured depth, orientation, and true vertical depth are known, the drill bit can be steered along a drilling plan. The present invention is susceptible to embodiments of different forms. There are shown in the drawings, and herein will be described in detail, specific embodiments with the understanding that the present invention is to be considered an exemplification of the principles and is not intended to limit the present invention to that illustrated and described herein.

This invention presents a system and method for accurately and continuously determining downhole depth in real time by comparing information from two or more geological sensors positioned at a fixed distance apart. The sensors may include, but are not limited to, gamma-ray, neutron, density, porosity, and ultrasonic sensors. An artificial intelligence algorithm is then used to determine the time difference between measurements taken by the first and any subsequent geological sensors at the same point. The time difference can be determined whether or not the speed at which the sensors are moving changes during the drilling. Knowing that the same geological point was measured by two or more different geological sensors separated by a fixed distance over a set period of time allows for the continuous calculation of downhole Measured Depth (MD) and Rate of Penetration (ROP). Furthermore, this estimated depth can be combined with orientation sensors also to determine the True Vertical Depth (TVD) and wellbore trajectory at any given depth.

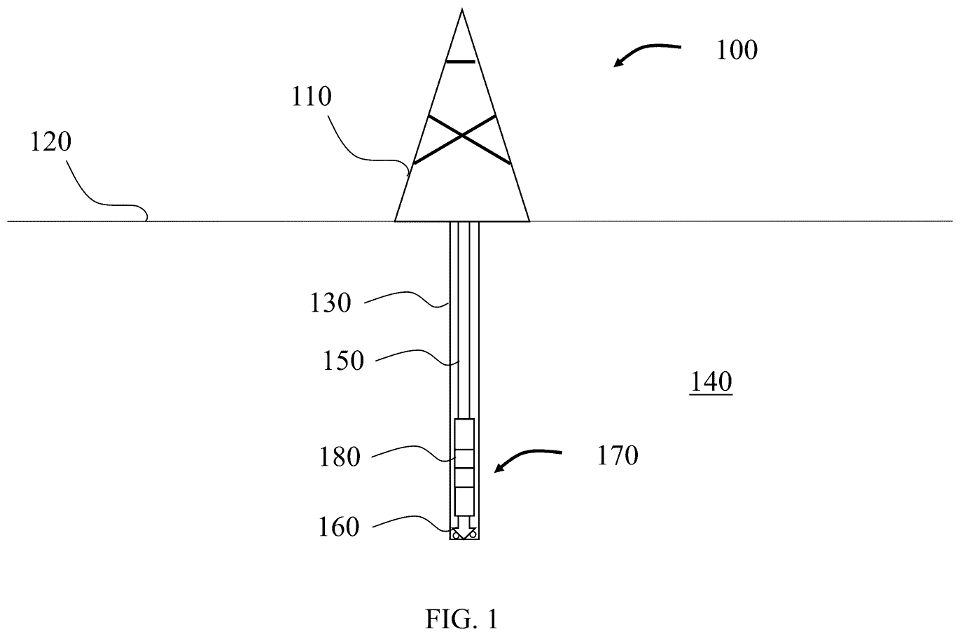

FIG. 1 shows a diagram of a drilling system 100 that includes a drilling rig 110 disposed on a surface 120 and above a borehole 130 in an earth formation 140. Disposed in the borehole 130 is drill string 150 with a drill bit 160 at the bottom of the borehole 130. Above the drill bit 160 is a bottom hole assembly 170 that includes two or more sensors 180 configured to measure at least one parameter of interest of the earth formation 140.

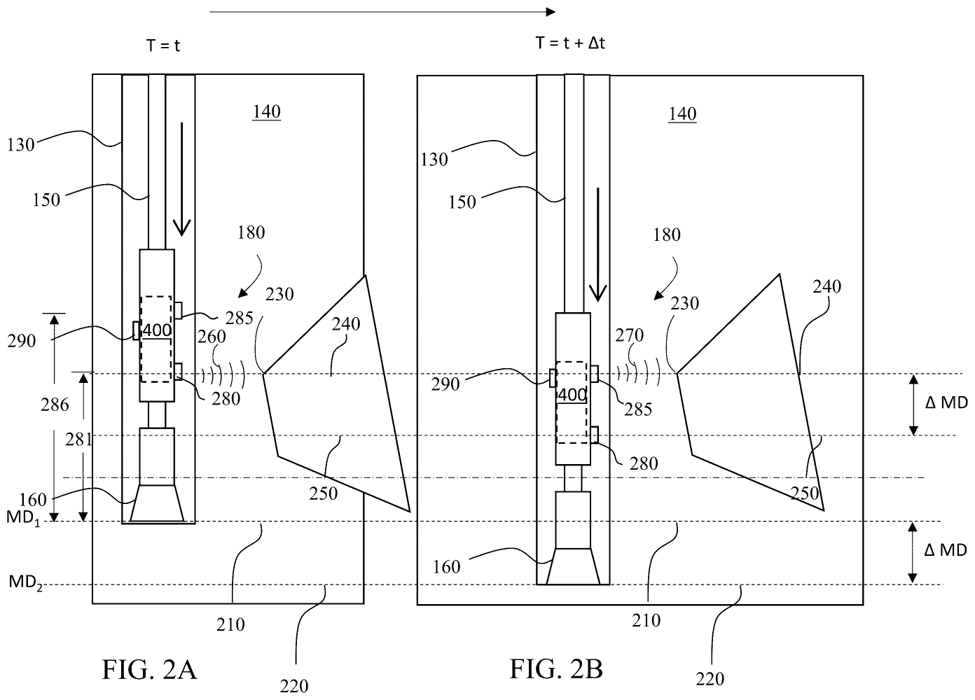

FIGS. 2A-2B show diagrams of the bottom hole assembly 170 and the drill bit 160 in the borehole 130 at two different times T and T+Δt. Within the formation 140 is a feature of interest 230. This may be a part of the formation with a different porosity, density, composition, or other detectable geological parameter that can be measured by the sensors 180. The sensors 180 are shown as a first sensor 280 and a second sensor 285. The first sensor 280 and the second sensor 285 are longitudinally separated along the bottom hole assembly 170 by a known distance such that they will travel past the same part of the formation at different times as the bottom hole assembly 170 travels through the borehole. The distance 281 is between the bottom of the drill bit 160 and the first sensor 280. The distance 286 is between the bottom of the drill bit 160 and the second sensor 285. The known distance between the sensors 280, 285 is the positive difference between the distance 286 and the distance 281. When drilling forward, the first sensor 280 will encounter parameters of the borehole 130 and the formation 140 before the second sensor 285, and the physical distance between the first sensor 280 and the second sensor 285 will be known. Thus, the depth traveled can be determined by identifying when the feature of interest 230 encountered by the first sensor 280 is encountered by the second sensor 285, even if the speed of travel of the sensors 280, 285 changes while passing a feature of interest 230 in the formation 140. With the use of a time index, the rate of penetration can also be estimated and confirmed by measuring the time difference between encountering the same parameter in the same position by each of the sensors 180, independent of the speed of travel at which the sensors 280, 285 passed the same feature of interest 230. The depth line 210 indicates the measured depth of the drill bit 160 at time T. The depth line 220 indicates the measured depth of the drill bit 160 at time T+Δt. Likewise, the depth line 240 indicates the measured depth that coincides with the feature of interest 230, and the depth line 250 indicates the position of the first sensor 280 when the second sensor 285 is aligned with the depth line 240. In practice, the known distance (the distance 286 minus the distance 281) should be the same as the distance between the depth line 220 and the depth line 210, which is also the same as the distance between the depth line 240 and the depth line 250. In the event that the entirety of the borehole 130 is vertical, the measured depth (depth lines 210, 220) would also be the true vertical depth at their respective times; however, this is almost never the case since boreholes usually have some sections that are slanted or horizontal. Sensor pulses 260 are shown being emitted by the first sensor 280 to interact with the feature of interest 230. The reflection of the sensor pulses 260 can be detected by the first sensor 280 at time T. The emission of the sensor pulses 260 are optional since the first sensor 280 may be active or passive, thus, the feature of interest 230 may be emitting its own signal, such as natural radioactivity. Herein, the first sensor 280 is shown with transmitter capability; however, this is illustrative and exemplary only. The pulses 260 may be emitted by one or more separate transmitters in some embodiments. Herein the sensor pulses 270 are shown being emitted by the second sensor 285 to interact with the feature of interest 230. The reflection of the sensor pulse can be detected by the second sensor at time T+Δt. The emission of the sensor pulses 270 are optional since the first sensor 285 may be active or passive, thus, the feature of interest 230 may be emitting its own signal, such as natural radioactivity. The second sensor 285 is shown with transmitter capability; however, this is illustrative and exemplary only. In some embodiments, the pulses 270 may be emitted by one or more separate transmitters in some embodiments. An orientation sensor 290 may be disposed in or on the bottom hole assembly 170 and configured to detect the orientation of the bottom hole assembly 170 and generate a signal indicating its orientation. In some embodiments, the orientation sensor 290 may be, but is not limited to, one of: a magnetometer, accelerometer, a tilt sensor, or a gyroscope.

The sensors 280, 285 may be directional or omnidirectional. The sensors 280, 285 may be configured to act as active or passive sources and receivers. The sensors 280, 285 may include any suitable gamma ray (natural and artificial), density, porosity, electromagnetic, ultrasonic, gravimetric, and acoustic sensor configured for measuring properties of the borehole 130 or the formation 140. In some embodiments, the first sensor 280 and the second sensor 285 may be of the same type (i.e. both natural gamma detectors); however, in other embodiments, the first sensor 280 and the second sensor 285 may be of different types, (i.e., one gamma detector and one acoustic-density sensor), so long as both sensors are capable of detecting, with suitable resolution, the feature of interest 230, as would be understood by a person of ordinary skill in the art. The first sensor 280 and the second sensor 285 may be selected to have detection and resolution capabilities to detect features of interest 230 that are not detectable by similar sensors used to detected features of the borehole 130. While the sensors 280, 285, 290 are shown as individual units, this is exemplary and illustrative only, as the sensors 280, 285, 290 may include additional redundant sensors of the same or similar type. In some embodiments (not shown), there may be three or more sensors longitudinally spaced along the bottom hole assembly 170 for detecting the feature of interest 230.

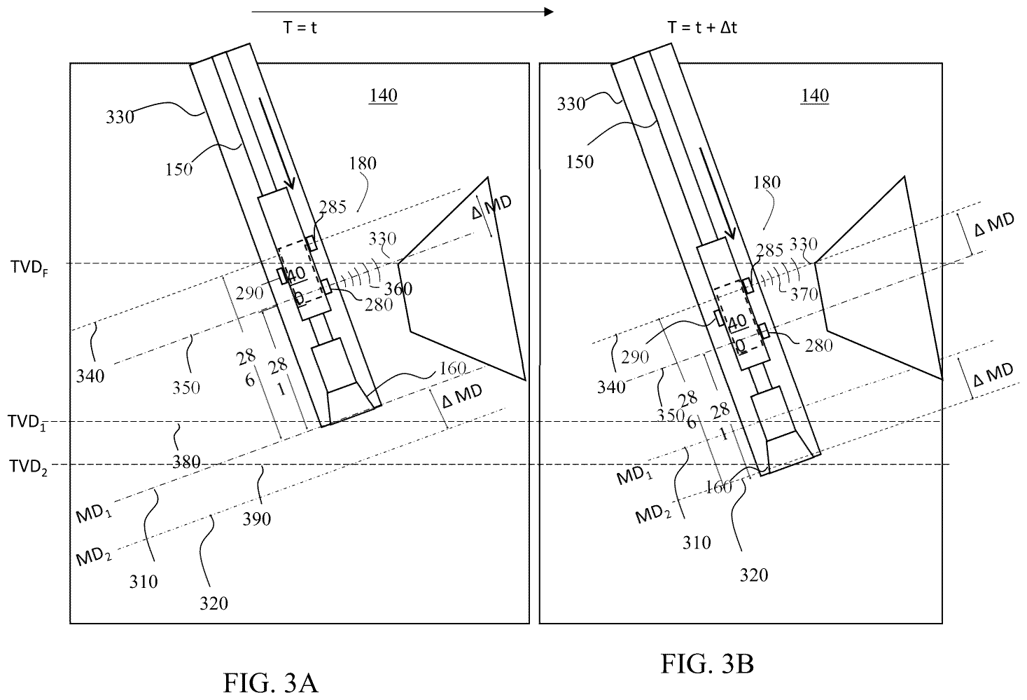

FIGS. 3A-3B show diagrams of the bottom hole assembly 170 and the drill bit 160 in a non-vertical borehole 330 at two different times T and T+Δt. The non-vertical borehole 330 may be another borehole within the formation 140 or it may be a different segment of the same borehole as the borehole 130. Within the formation 140 is a feature of interest 330. This may be a part of the formation with a different porosity, density, composition, or other detectable geological parameter that can be measured by the sensors 180. Again, the sensors 180 are shown as the first sensor 280 and the second sensor 285, which are longitudinally separated along the bottom hole assembly 170 by a known distance such that they will travel past the same part of the formation at different times as the bottom hole assembly 170 travels through the borehole. When drilling forward, the first sensor 280 will encounter parameters of the borehole 330 and the formation 140 before the second sensor 285, and the physical distance between the first sensor 280 and the second sensor 285 will be known. Thus, the measured depth and rate of penetration can be estimated and confirmed by measuring the time difference between encountering the same parameter in the same position by each of the sensors 180. The depth line 310 indicates the measured depth of the drill bit 160 at time T. The depth line 320 indicates the measured depth of the drill bit 160 at time T+Δt. Likewise, the depth line 340 indicates the measured depth that coincides with the feature of interest 330, and the depth line 350 indicates the position of the first sensor 280 when the second sensor 285 is aligned with the depth line 340. In practice, the known distance (the distance 286 minus the distance 281) should be the same as the distance between the depth line 320 and the depth line 310, which is also the same as the distance between the depth line 340 and the depth line 350. Since the borehole 330 is not vertical, the change in the measured depth (depth lines 310, 320) will be different from a change in true vertical depth, shown at their respective times by line 380 (at time T) and by line 390 (at time T+ΔT). Sensor pulses 360 are shown being emitted by the first sensor 280 to interact with the feature of interest 330. The reflection of the sensor pulses 360 can be detected by the first sensor 280 at time T. The emission of the sensor pulses 360 are optional since the first sensor 280 may be active or passive, thus, the feature of interest 330 may be emitting its own signal, such as natural radioactivity. Also, while not shown, the pulses 360 may be emitted by one or more separate transmitters in some embodiments. Likewise, sensor pulses 370 can be emitted by the second sensor 285 to interact with the feature of interest 330. The reflection of the sensor pulses 370 can be detected by the second sensor at time T+Δt. The emission of the sensor pulses 370 are optional since the first sensor 285 may be active or passive, thus, the feature of interest 330 may be emitting its own signal, such as natural radioactivity. Also, while not shown, the pulses 370 may be emitted by one or more separate transmitters in some embodiments.

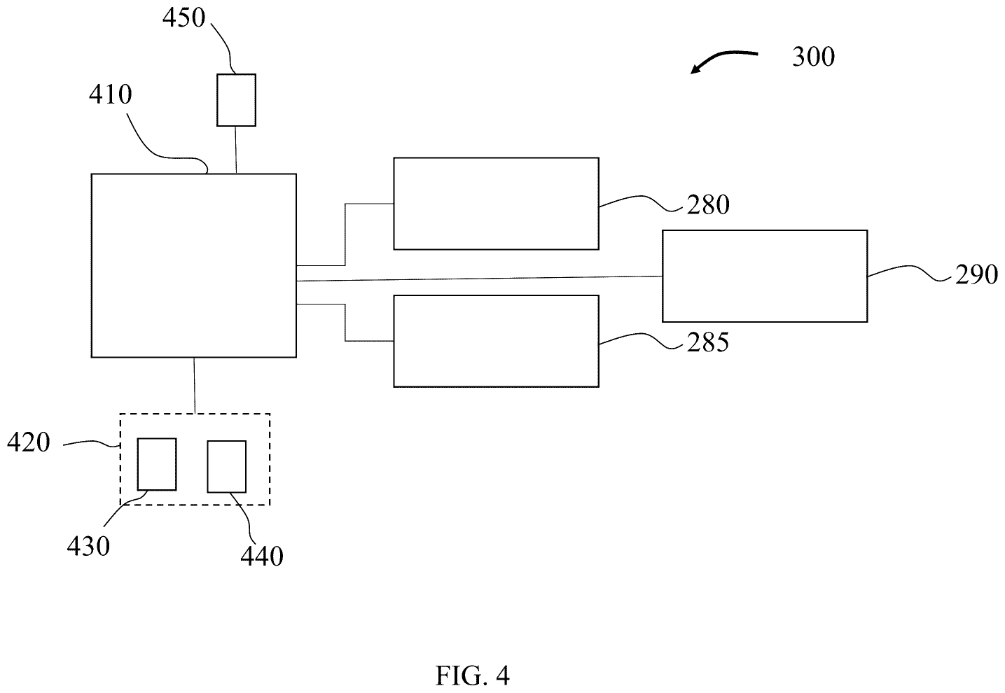

FIG. 4 shows a diagram of the sensor system 400 enclosed in the bottom hole assembly 170. The sensor system 400 includes the first sensor 280, the second sensor 285, the orientation sensor 290. In the event that the sensor system 400 is being used on a straight vertical bore, the orientation sensor 290 is optional. The sensor system 400 also includes a processor 410 and a memory 420. The processor 410 is in electrical communication with each of the first sensor 280, the second sensor 285, and the orientation sensor 290. Information from these sensors 280, 285, 290 is received by the processor 410 and recorded in the memory 420. The processor 410 may also be configured to execute programs from the memory 420 that use the data from one or more of the sensors 280, 285, 290 to estimate one or more of: measured depth in the borehole, drilling angle, rate of penetration, and true vertical depth. The memory 420 may be centralized or distributed (made up of one or more memories 430, 440, which may be dedicated to specific functions). The memories 420, 430, 440 may be any suitable computer memory device or medium, including, but not limited, to, a ROM, an EPROM, an EEPROM, a flash memory, an optical disk, a solid state drive, and a hard drive. The sensor system 400 may also include a clock 450. The clock 450 part of the processor 410 or ancillary to it. In some embodiments, the clock 450 is optional.

As shown here, the program memory 430 may include programs to be executed by the processor 410, and the data memory 440 may store data gathered by the sensors 280, 285, 290. The clock 450 may be provide a time index for the data from the sensors 280, 285, 290 that can be stored in the data memory 440. The program memory 430 may hold algorithms for estimation of rate of penetration, drilling angle, inclination, azimuth, true vertical depth, and real-time processing and extraction of time-series trends that can be executed by the processor 410. In some embodiments, programs in the memory 430 may, when executed, perform time-varying pattern matching, since the rate at which the sensors pass a through the borehole may or may not vary, to detect the feature of interest 230 in each data trend produced by each of the sensors 280, 285 and compute the time difference between detection of the feature of interest 230 to continuously derive the axial speed per interval and the total distance drilled over the interval. The memory 440 may also be configured to store a copy of a drilling plan so that information from the sensors 280, 285, 290 can be used to determine where the drill bit 160 is located along the drill plan. Also, the memory 430 may include one or more programs that, when executed, are configured to compare information from the first sensor 280 and the second sensor 285 to determine the timing of when each encounter aspects of the formation 140 such as the feature of interest 230. In some embodiments, the memory 440 may include pre-downloaded logs of formation or borehole data, the well plan, and/or expected geological features that can be compared with the trends recorded from the sensors 280, 285 during the present drilling.

In some embodiments, the orientation sensor 290 may be made up of multiple triaxial orientation sensors. Signals from multiple sensors (Multi-sensor fusion) may be used to enhance the accuracy of the orientation estimation. The application of multi-sensor fusion can enhance accuracy so that the orientation can be accurately estimated while drilling is in progress, instead of pausing the drilling process to perform an orientation determination.

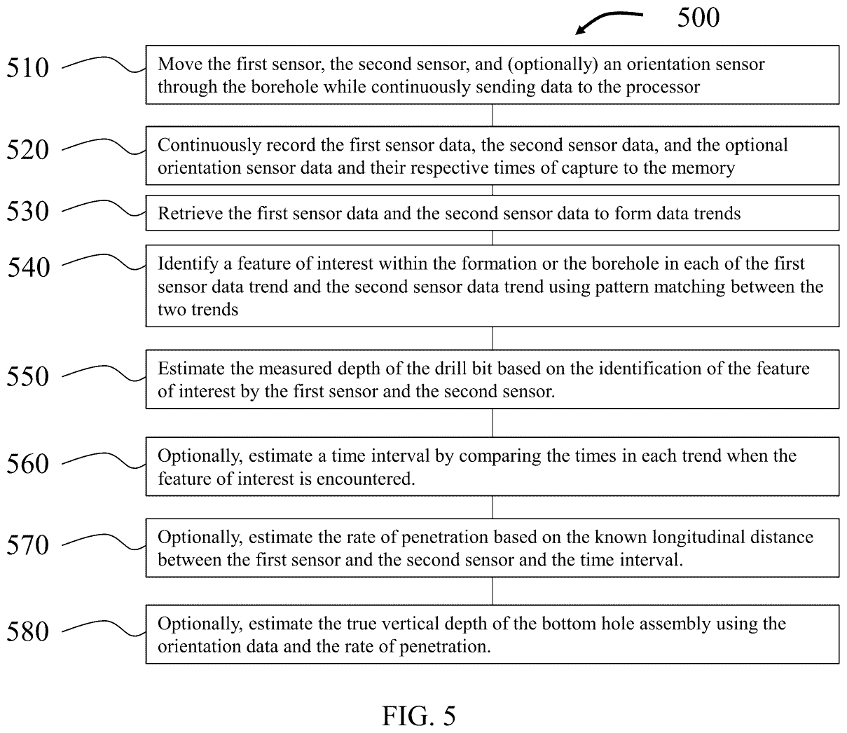

FIG. 5 shows a flow chart for performing a method 500 of determining the measured depth of drill bit 160 using the sensor system 400. The method 500 also includes steps for the optional determination of rate of penetration and true vertical depth. In step 510, the bottom hole assembly 170 is positioned in the borehole 130 and the first sensor 280, the second sensor 285, and the orientation sensor 290 continuously send data about the formation 140 to the processor 410. In step 520, the processor 410 records the first sensor data, the second sensor data, and the orientation sensor data and their respective times of capture to the memory 420. In step 530, the processor 410 retrieves the first sensor data and the second sensor data to detect data trends. In step 540, the processor 410 identifies the feature of interest 230 within the formation 140 (or alternatively within the borehole 130) in each of the first sensor data trend and the second sensor data trend. The identification of the feature of interest 230 may be performed by time-varying pattern matching of the first sensor data trend and the second sensor data trend. Suitable pattern-matching algorithms may include to Advanced Sequential Pattern Matching Algorithms (ASPMAs) and Deep Neural-Network-Based Algorithms (DNNBAs). Suitable ASPMAs have unique temporal and structural characteristics that increase efficiency and accuracy of processing of complex static and time-varying tasks as would be understood by a person of ordinary skill in the art. The ASPMAs may include, but are not limited to, Dynamic Time Warping (DTW), Time Warp Edit Distance (TWED), Longest Common Subsequence (LCSS), Correlation Filtering, Cross-Correlation, Convolution, Edit Distance with Real Penalty (ERP), and Subsequence Dynamic Time Warping (SDTW). All suitable ASPMAs proficiently and efficiently handle temporal variations inherent in the data. Optionally, DNNBAs may be used with ASPMAs to further improve the pattern matching by reducing complexity and increasing efficiency. DNNBAs may be configured to capture intricate sequential and structural patterns that increase precision of pattern recognition. DNNBAs may include, but are not limited to, Hidden Markov Models (HMM), Recurrent Neural Networks (RNN), Convolutional Neural Networks (CNN), Graph Neural Networks (GNN), Transformers, Sequence (Seq2Seq) models, and Reinforcement Learning Algorithms (RLAs). The DNNBAs are configured to perform at least one of: grid-like data interpretation and discern complex relational patterns. The CNNs and GNNs may be configured to perform both grid-like data interpretation and discern complex relational patterns. Transformers are deep learning models that use self-attention and differentially weight the significance of inputs. As would be understood by a person of ordinary skill in the art, transformers show high efficacy in handling sequential data, dealing with dependencies across long sequences, and are effective for tasks involving sequence alignment and translation. RLAs may be configured to adapt dynamically and refine model predictions over time. RLAs may be used for training the core of advanced decision making and refined inference in the system. One or more ASPMAs and DNNBAs may be used in combination. For example, in one embodiment, Dynamic Time Warping may be used with Recursive Neural Networks. This combination may improve the alignment of the signals detected by the first sensor 280 and the second sensor 285. In some embodiments, course signal fitting may be performed by Dynamic Time Warping, and fine adjustments to the matching may be performed using Recursive Neural Networks. In some embodiments, specialized hardware, such as Digital Signal Processing (DSP) chips, Field Programmable Gate Arrays (FPGAs), Machine Learning Processing Units, Tensor Processing Units, or/and AI Accelerators, may be employed to reduce errors and reduce the number of computations required for performing pattern recognition. Since the sensors 280, 285 are longitudinally separated, the location in trends of the feature of interest 230 will occur at different times. In step 550, the processor compares each trend when the feature of interest 230 is encountered and uses the comparison to identify when the change in MD (the delta MD), which is known from the fixed distance between sensors, has occurred. Since the delta MD is known from the fixed distance between the sensors, the overall MD for the drill bit 160 is then updated by a delta MD increment. In step 560, the processor compares the times in each trend when the feature of interest 230 is encountered and uses the comparison to determine the time interval (Δt) between encounters with the feature of interest 230. In step 570, the processor 410 estimates the rate of penetration based on the known longitudinal distance between the first sensor 280 and the second sensor 285 and the time interval and the MD is updated. In step 580, the processor 410 may estimate the true vertical depth of the bottom hole assembly 170 using the orientation data and the rate of penetration.

While embodiments in the present disclosure have been described in some detail, according to the preferred embodiments illustrated above, it is not meant to be limiting to modifications such as would be obvious to those skilled in the art.

The foregoing disclosure and description of the disclosure are illustrative and explanatory thereof, and various changes in the details of the illustrated apparatus and system, and the construction and the method of operation may be made without departing from the spirit of the disclosure.

What is claimed is:

1. A method of determining measured depth in a borehole, comprising the steps of:
moving a first sensor and a second sensor through a borehole while continuously sending data to a processor, wherein the first sensor and the second sensor are spaced longitudinally apart in the borehole by a known distance;
continuously recording data from first sensor and the second sensor, using the processor, to a memory, wherein the processor and the memory are in the borehole;
forming data trends based on the first sensor data and the second sensor data;
identifying a feature of interest in each of the first sensor data trend and the second sensor data trend using time-varying pattern matching between the two trends; and
continuously estimating a measured depth using the feature of interest identification in the first sensor data trend and the second sensor data trend and the known distance between the first sensor and the second sensor.

2. The method of claim 1, wherein the first sensor and the second sensor are moved through the borehole at a variable speed and wherein data trends are formed independent of variations in speed of the first sensor and the second sensor.

3. The method of claim 1, further comprising:
moving an orientation sensor through the borehole with the first sensor and the second sensor;
continuously recording orientation data from the orientation sensor, using the processor, to the memory; and
continuously estimating a true vertical depth using the measured depth and the orientation data.

4. The method of claim 1, further comprising:
moving a clock through the borehole with the processor;
recording time information associated with the first sensor data trend and the second sensor data trend;
continuously estimating a time interval by comparing the time in each of the first sensor data trend and the second sensor data trend when the feature of interest is encountered by its respective sensor; and
estimating a rate of penetration based on the known distance between the first sensor and the second sensor and the time interval.

5. The method of claim 1, wherein the first sensor and the second sensor are each one of: an acoustic sensor, a gamma-ray sensor, a neutron sensor and an ultrasonic sensor.

6. The method of claim 1, further comprising at least one of: filtering, scaling, normalizing, and transforming the sensor data into a suitable format for the pattern matching techniques before forming the data trends.

7. The method of claim 1, wherein the pattern matching comprises using at least one of:
Advanced Sequential Pattern Matching Algorithms and Deep Neural-Network Based Algorithms.

8. The method of claim 7, wherein the Advanced Sequential Pattern Matching Algorithms comprise one or more of: Dynamic Time Warping (DTW), Time Warp Edit Distance (TWED), Longest Common Subsequence (LCSS), Correlation Filtering, Cross-Correlation, Convolution, Edit Distance with Real Penalty (ERP), FastDTW, and Subsequence Dynamic Time Warping (SDTW).

9. The method of claim 7, wherein the Deep Neural-Network Based Algorithms comprise one or more of: Hidden Markov Models (HMM), Recurrent Neural Networks (RNN), Convolutional Neural Networks (CNN), Graph Neural Networks (GNN), Transformers, Sequence (Seq2Seq) Neural Network-based models, and Reinforcement Learning Algorithms.

10. The method of claim 1, wherein the time-varying pattern matching is implemented on one of: a Digital Signal Processor (DSP), a machine learning device, a tensor processing unit, and an artificial intelligence accelerator.

11. A non-transitory computer-readable medium product, the medium containing instructions thereon that, when executed by a processor, executes a method, the method comprising the steps of:
continuously recording data from a first sensor and a second sensor to a memory, using a processor, wherein the first sensor, the second sensor, the processor and the memory are moving in a borehole;
retrieving the first sensor data and the second sensor data and forming data trends based on the first sensor data and the second sensor data;
identifying a feature of interest in each of the first sensor data trend and the second sensor data trend using time-varying pattern matching between the two trends; and
estimating a measured depth using the feature of interest identification in the first sensor data trend and the second sensor data trend and a known distance between the first sensor and the second sensor.

12. The non-transitory computer-readable medium product of claim 11, wherein the first sensor and the second sensor are moving at a variable speed and wherein the data trends are formed independent of variations in speed of the first sensor and the second sensor.

13. The non-transitory computer-readable medium product of claim 11, wherein the medium further contains instructions thereon that, when executed, by the processor, executes the steps of:
continuously recording orientation data from an orientation sensor moving through the borehole with the first sensor and the second sensor; and
estimating a true vertical depth using the measured depth and the orientation data.

14. The non-transitory computer-readable medium product of claim 11, wherein the medium further contains instructions thereon that, when executed, by the processor, executes the steps of:
recording time information associated with the first sensor data trend and the second sensor data trend; and
estimating a time interval by comparing the time in each of the first sensor data trend and the second sensor data trend when the feature of interest is encountered by its respective sensor; and
continuously estimating a rate of penetration based the known distance between the first sensor and the second sensor and the time interval.

15. The non-transitory computer-readable medium product of claim 11, wherein the medium comprises at least one of: i) a ROM, ii) an EPROM, iii) an EEPROM, iv) a flash memory, v) an optical disk, vi) a solid state drive, and vii) a hard drive.

16. An apparatus for detecting properties of an earth formation or borehole when positioned within the borehole, the apparatus comprising:
a first sensor;
a second sensor spaced longitudinally apart from the first sensor by a known distance;
an orientation sensor;
a processor in electronic communication with the first sensor and the second sensor; and
a memory configured to store data from the first sensor and the second sensor.

17. The apparatus of claim 16, wherein the first sensor and the second sensor are selected from a list of passive gamma ray detectors, active gamma ray detectors, ultrasonic sensors, gravimeters, acoustic sensors, and magnetometers.

18. The apparatus of claim 16, further comprising an orientation sensor in electronic communication with the processor and wherein the memory is configured to store data from the orientation sensor.

19. The apparatus of claim 16, further comprising a clock.

20. The apparatus of claim 16, wherein the processor includes a clock circuit and wherein the memory comprises a program memory and a data memory.
